(19) United States
(12) Patent Application Publication
(10) Pub. No.: US 2007/0163393 A1
(43) Pub. Date: Jul. 19, 2007

(54) WEARABLE BOTTLE OPENING DEVICE

(76) Inventors: Robert Ondeck, San Diego, CA (US); Staci Kerman, San Diego, CA (US)

Correspondence Address: COHEN & GRIGSBY, P.C., 11 STANWIX STREET, 15TH FLOOR, PITTSBURGH, PA, 15222, US

(21) Appl. No.: 11/624,839

(22) Filed: Jan. 19, 2007

Related U.S. Application Data
(60) Provisional application No. 60/760,160, filed on Jan. 19, 2006.

(51) Int. Cl. B67B 7/16

(52) U.S. Cl. 81/3.57; 81/3.55

(57) ABSTRACT

The invention is a wearable accessory item that functions as a bottle opener and a method of using same. Accessory item has a strap and mounting plate attached thereto. Mounting plate has first and second surfaces and a third surface therebetween. Pry plate and pry bar each project from one of mounting plate surfaces and are each positioned in a plane. Pry plate and pry bar each have a surface that engages surfaces of bottle cap inserted into opening therebetween. In another embodiment, the invention is an adapter for use with a conventional wearable accessory item.

This application claims priority to U.S. Provisional Patent Application No. 60/760,160, filed on Jan. 19, 2006.

### FIELD OF THE INVENTION

The invention relates to a wearable accessory item, and specifically to a wearable accessory item comprising a bottle opening device and method of using same.

### BACKGROUND OF THE INVENTION

A large percentage of the population enjoys recreational activities such as hiking, biking, golfing, and other outdoor activities. Often times, these activities include socializing with one's friends and/or business acquaintances. Sometimes, the socializing includes consuming beverages that are sold in bottles having caps. These caps, however, can be difficult to remove, and often in these settings, bottle openers are not available. Therefore, there is a need for a bottle opener that is easily accessible when one is outdoors and that is easy for the user to remember to carry with him/her when leaving home to enjoy the recreational activities. One solution to this problem is to include a bottle opening device as part of an accessory item that most people wear every day so that the bottle opener is nearby and not easily forgotten when leaving home.

### SUMMARY OF THE INVENTION

The present invention meets this need by providing a wearable accessory item such as a watch, belt, bracelet, anklet, or necklace that is worn or attached to a wearable article such as a backpack while engaging in any number of activities and that includes a bottle opener so that one has an opener nearby, particularly when in social settings with friends or business acquaintances. Generally, in an embodiment the claimed invention provides a wearable accessory item that comprises a strap for attachment to the wearer's body or to a wearable article, a mounting plate, a pry plate, and a pry bar. Strap can be a band. The mounting plate has first and second surfaces and a third surface therebetween. There is an attaching means that attaches the mounting plate to the strap. The pry plate projects from the third surface of the mounting plate and has a first engaging surface that engages a surface of the bottle cap. The pry bar has a second engaging surface that engages a lip of the bottle cap. In examples, second engaging surface is opposed to first engaging surface. There is an opening between pry plate and pry bar that has a size and shape that is generally complementary to the size and shape of at least a portion of the bottle cap. In use, a portion of the bottle cap is positioned in the opening and the surface of bottle cap is forced against the first engaging surface of pry plate as the user exerts a force on the lip of bottle cap, causing the second engaging surface to engage the lip of the bottle cap and remove the bottle cap from the bottle.

In another embodiment, the invention is an adapter for use with a conventional wearable accessory item. The adapter is configured to integrate with the accessory item and has attachment means to attach the adapter thereto. Adapter comprises a mounting plate, pry plate, and pry bar. The pry plate and pry bar each project from a surface of the mounting plate. There is an opening therebetween into which at least a portion of the bottle cap is able to fit. The adapter is used as described above.

In another embodiment, the claimed invention is a method of using the wearable accessory item to remove a bottle cap from a bottle.

Accordingly, it is an object of the present invention to provide a wearable accessory item that comprises a bottle opening device that can be worn while participating in a number of activities.

It is still a farther object of the present invention to provide a wearable accessory item that is both functional as a bottle opening device and aesthetically pleasing.

It is still a further object of the present invention to provide an adapter that integrates with a conventional accessory item to convert the accessory item to a bottle opening device.

It is still a further object of the present invention to provide a method of using the wearable accessory item to remove a bottle cap from a bottle.

Other objects, features, aspects and advantages of the present invention will become better understood or apparent from the following detailed description, drawings, and appended claims of the invention.

### BRIEF DESCRIPTION OF THE DRAWINGS

FIG. 1 shows examples of embodiments of the present invention in which the wearable accessory item is a wrist watch.

FIG. 2 shows isometric views of an alternate example of an embodiment of the wearable accessory item with and without a bottle inserted therein.

FIG. 3 shows isometric views of an example of an embodiment of the wearable accessory item with and without a bottle inserted therein.

FIG. 4A shows a side view of an example of an embodiment of the wearable accessory item and FIG. 4B shows an isometric view of an example of an embodiment of the wearable accessory item.

FIGS. 5A and 5B show top views of an example of an embodiment of the wearable accessory item; FIG. 5C shows an example of an embodiment of the present invention in which the wearable accessory item is a belt buckle.

FIG. 6 shows isometric views of examples of an embodiment of the present invention in which the wearable accessory item is a buckle with and without a bottle inserted therein.

FIG. 7 shows perspective views of examples of an embodiment of the wearable accessory item secured to a belt loop and a bag.

FIG. 8 shows a top view of an example of an embodiment of the claimed adapter in combination with a strap having a buckle.

FIG. 9 shows an isometric view of an example of an embodiment of the claimed adapter.

FIG. 10 shows a top view of an example of an embodiment of the claimed adapter.

FIG. 11 shows a bottom view of an example of an embodiment of the claimed adapter.

FIG. 12 shows a side view of an example of an embodiment of the claimed adapter showing an alternate means of attachment.

### DETAILED DESCRIPTION OF EMBODIMENTS OF THE INVENTION

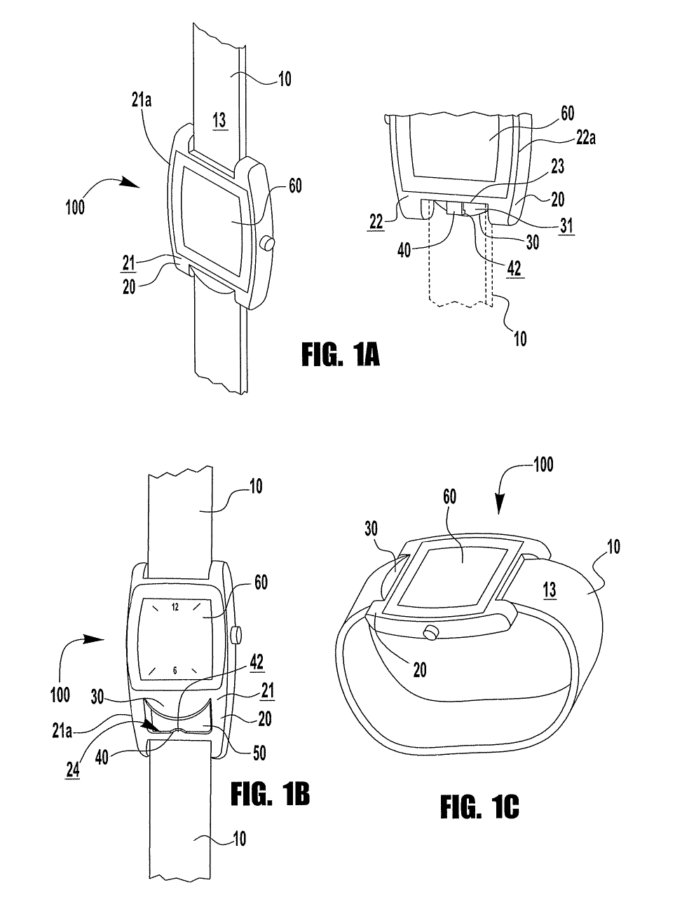

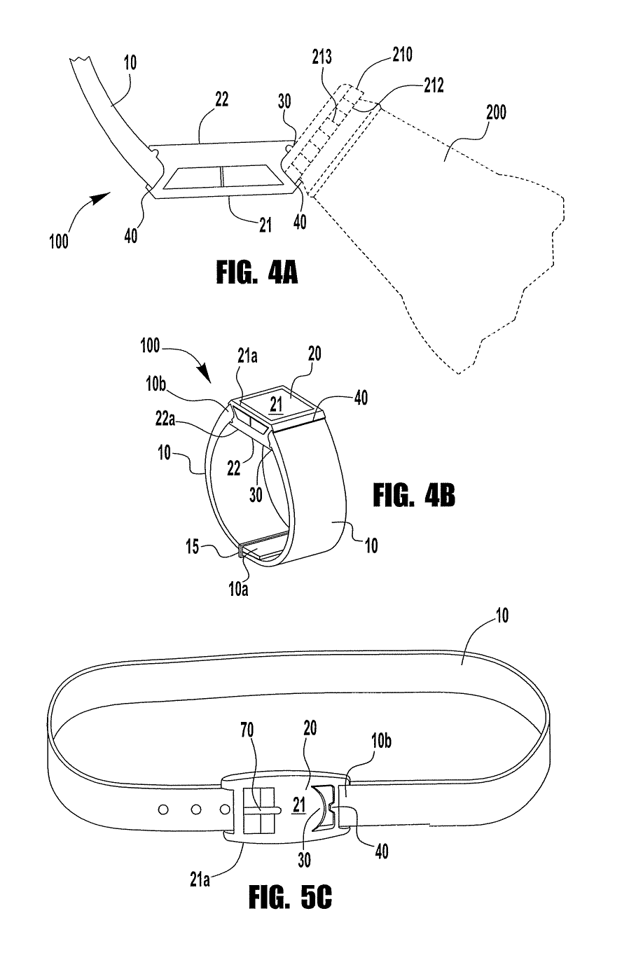

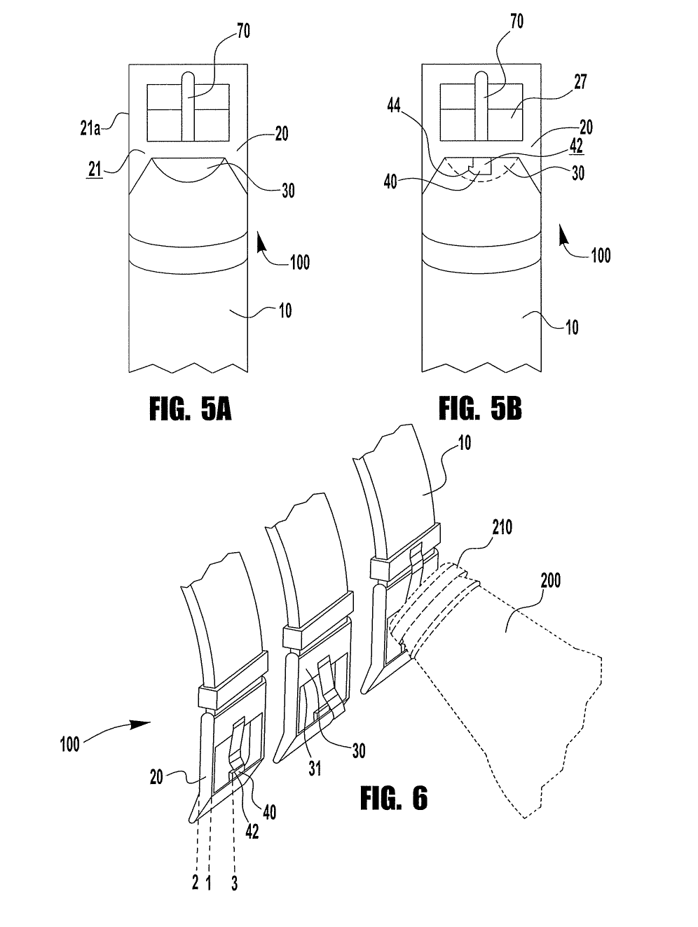

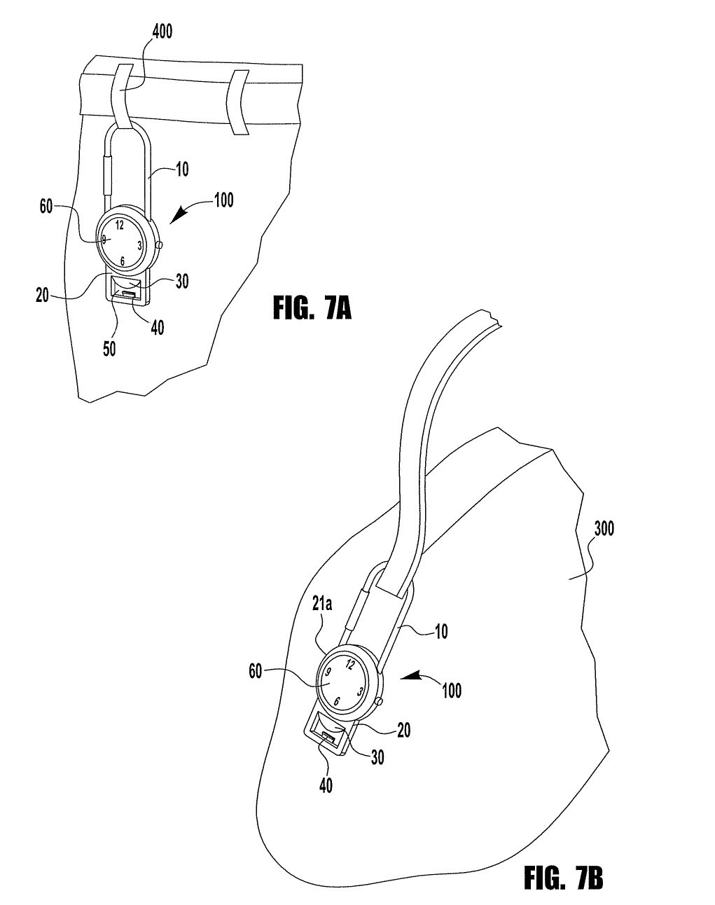

As shown generally in the figures, in an embodiment, the present invention is a wearable accessory item 100 comprising a strap 10, a mounting plate 20, a pry plate 30, and a pry bar 50. The wearable accessory item 100 may be, for examples, a wrist watch (FIG. 1), a buckle (FIG. 5-6), a wrist or an ankle bracelet (not shown), a clip-on watch (FIG. 7), or any other wearable accessory item. These examples are not intended to be limiting, however, because the wearable accessory item 100 may be any item that can be worn on or around the body or attached to a wearable article such as a backpack. The strap 10 secures the accessory item to a wearer's body, such as the wrist, waist, or ankle, or to a wearable item, such as a belt, belt loop, or backpack, for example. In an example, strap 10 is a band (FIG. 1C, 4B). In another example, strap 10 is adjustable (FIG. 5C). In another example, strap is a clip (FIG. 7). Band 10 is made of any suitable material, including leather, nylon, plastic, aluminum, titanium, nickel plated steel, stainless steel, or a combination thereof. The strap 10 is at least one piece, each at least one piece having first and second ends 10a, 10b. In the examples shown in FIGS. 1, 2, and 5C, strap 10 is one piece. In the examples shown in FIGS. 3 and 4, strap 10 is two pieces. Optionally, strap 10 further comprises a securing means 15 to secure wearable accessory item 100 to wearer's body or other wearable item. In examples, securing means 15 is attached to first end 10a of at least one piece of strap and is a loop (FIG. 4B), a buckle, a hook and latch system, a snap, or any other securing or closure means capable of connecting known in the art. Second end 10b of strap 10 is attached to mounting plate 20 by attachment means 25, described in more detail below. For example, as shown in FIG. 5, second end 10b of strap 10 is looped around a bar on mounting plate 20. As shown in FIGS. 3 and 4, at least one of the pieces comprising strap 10 is removably inserted into opening 50 for removal prior to use.

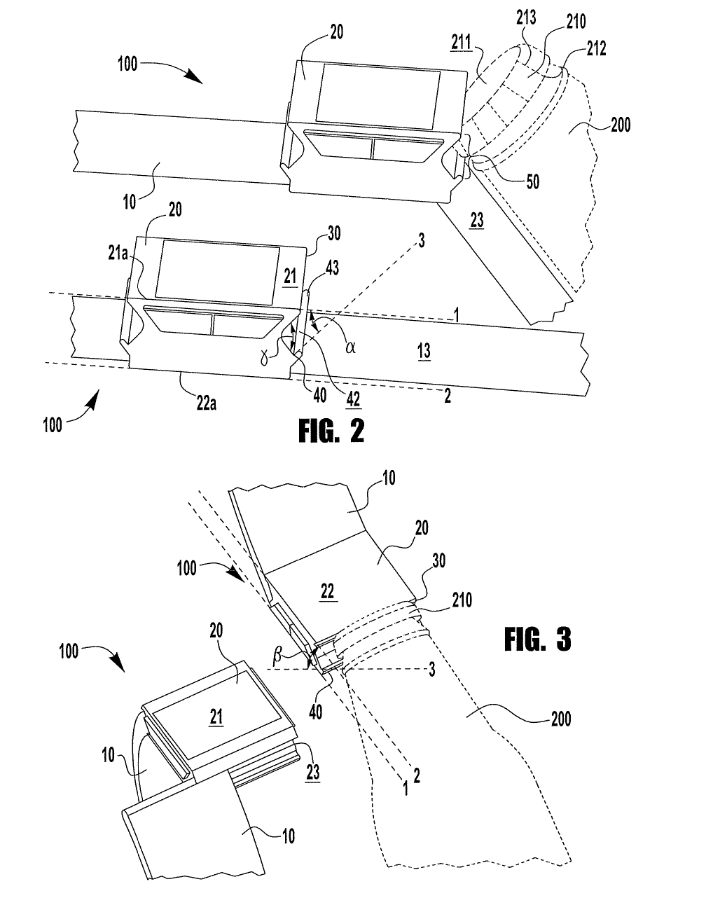

The wearable accessory item 100 further comprises a mounting plate 20 that has first 21 and second surfaces 22 and a third surface 23 therebetween. In an example, mounting plate 20 has a fourth surface 24, as shown in FIGS. 1B and 5-7. First and second surfaces 21, 22 each have an edge 21a, 22a that defines first and second planes 1, 2, respectively. In an example, first and second planes 1, 2 are substantially parallel. Edges 21a, 22a are either curved (FIG. 1), flat (FIGS. 2-6), or a combination thereof (FIG. 7). Mounting plate 20 has at least one attachment means 25 for attachment to the strap. Preferably, second end 10b of strap 10 attaches to attachment means 25. In an example, attachment means 25 comprises a spring-loaded bar to which second end 10b of strap 10 attaches (FIG. 1B). In another example, attachment means 25 comprises slots in mounting plate though which strap is woven or threaded. In other examples, mounting plate is substantially attached to or mounted on surface 13 of strap 10 such as by a hook and latch system, glue, epoxy, or other adhesive. Mounting plate 20 may be any size, shape, or material that does not interfere with the functionality of the claimed invention such that mounting plate 20 is able to stabilize the bottle cap 210 and avoid breakage and/or injury during use. In examples, mounting plate 20 has a thickness of about 1.5 cm to about 2.5 cm. Lengths of edges 21a, 22a, 23a range from about 30 mm to about 45 mm. In examples, mounting plate 20 is made from stainless steel, nickel-plated steel, pure or recycled metals, or titanium. In examples, mounting plate 20 is a solid piece of material (see FIGS. 1A, 1C, 2-4). In other examples, mounting plate 20 has at least one hole 27 extending therethrough (see FIGS. 1B, 5-7).

The wearable accessory item 100 further comprises a pry plate 30 and a pry bar 40. Pry plate 30 projects from the third surface 23 of the mounting plate 20. Although the examples in the figures generally show the pry plate 30 projecting from a side surface of the mounting plate 20, pry plate 30 may be positioned on any of the surfaces of the mounting plate 20 as long as the position does not interfere with the functionality of the claimed invention or of the wearable accessory item. Pry plate 30 may be of any shape that does not interfere with the purpose of the claimed invention, including semi-circular or arced (FIG. 1, 5, 7), flat or straight (FIGS. 2-4, 6), square (not shown), or rectangular (not shown). Pry plate 30 must be of sufficient length, width, and thickness that it is able to remove bottle cap 210 from bottle 200 without damage to wearable accessory item 100, bottle 200, and/or injury to the user of the accessory item 100. In examples, pry plate has a thickness ranging from about 1-3 mm, and length and width of pry plate range from about 0.6 to about 1.2 mm. In other examples, pry plate extends substantially the length of edge 23a of surface 23. Pry plate 30 has a first engaging surface 31 that engages a surface 211 of the bottle cap 210 when bottle cap 210 is positioned in opening 50, as described below. See FIGS. 2-4

Pry bar 40 has a second engaging surface 42 that is opposed to first engaging surface 31 and that engages a lip 212 of bottle cap 210 when bottle cap 210 is positioned in opening 50, as described below. See FIGS. 1-7. Pry bar 40 may be of any shape or size that does not interfere with the purpose of the claimed invention, including square, rectangular, and may optionally include a lip 44 that engages lip 212 of bottle cap 210. Pry bar must be of sufficient thickness that it is able to remove bottle cap 210 from bottle 200 without damage to wearable accessory item 100, bottle 200, and/or injury to the user of the item 100. In examples, pry bar 40 has a thickness that ranges from about 1-3 mm and a length and width ranging from about 0.2 to about 0.5 cm. In other examples, pry bar 40 is at least as long as the distance between any two ridges 213 on bottle cap 210. In examples shown in FIGS. 2-4, pry bar 40 extends substantially along edge 23a of third surface 23, but in examples shown in FIGS. 1, 5, and 6 has a width that equals at least about ten percent the length of edge 23a of third surface 23. Pry plate 30 is preferably wider than or substantially as wide as pry bar 40, as shown generally in the figures.

In an example, pry plate 30 and/or pry bar 40 are unitary with mounting plate 20. In other examples, pry plate 30 and pry bar 40 are not unitary with mounting plate 20 and are optionally made from a different material than mounting plate 20.

In examples, pry plate 30 is positioned in first plane 1 and pry bar 40 is positioned in a third plane 3 that is oriented relative to first plane 1 at angle α ranging from about 30° to about 90°. (See FIG. 2). In examples, an angle γ at intersection of pry plate 30 and third surface 23 is about 100% about 110°. In another example, pry plate 30 is positioned in second plane 2 and pry bar 40 is positioned in a third plane 3 that is oriented relative to second plane 2 at angle β ranging from about 30° to about 90°. (See FIG. 3). In other examples, third plane 3 in which pry bar 40 is positioned is substantially parallel to first and/or second planes 1, 2 (FIG. 6). Pry plate 30 and pry bar 40 may be substantially aligned or pry bar 40 may be positioned relative to pry plate 30 such that first and second engaging surfaces 31, 42 are substantially opposed. In examples where pry plate 30 projects from third surface 23 and pry bar 40 projects from fourth surface 24, pry bar 40 may have an angular projection towards first engaging surface 31 of pry plate 30.

There is an opening 50 between pry plate 30 and pry bar 40. Opening 50 may be any configuration including for example a space (FIG. 1A, 5), a hole (FIG. 1B, 6), or a channel (FIGS. 2-4). Preferably, opening 50 has a size and shape that is generally complementary to the size and shape of at least a portion of the bottle cap 210 such that the portion of the bottle cap 210 substantially fits within the opening 50 when first engaging surface 31 of pry plate 30 engages a surface 211 of bottle cap 210 and the second engaging surface 42 of pry bar 40 engages a lip 212 of the bottle cap 210 when surface 211 of bottle cap 210 is forced against first engaging surface 31 of pry plate 30 during use. In an example, the portion of the bottle cap 210 that sits within opening 50 is about ¼ to about ½ the surface area of the surface 211 of bottle cap 210. (See FIGS. 2-4, 6).

Optionally, the wearable accessory item 100 further comprises a decorative or fashion piece 60 that is attached to either the strap 10 or one of the surfaces 21, 22, 23, 24 of the mounting plate 20. The decorative or fashion piece 60 is any decorative or fashion item that can be secured to or embedded within the strap 10 or the mounting plate 20. In the example shown in FIG. 1, the decorative or fashion piece 60 is a watch face that is mounted on first surface 21 of mounting plate 20 (see FIG. 1). In another example, the decorative or fashion piece 60 is a rhinestone or other decorative stone secured to or embedded within at least one of the surfaces of either the mounting plate 20 and/or the strap 10 (not shown).

In another embodiment, the claimed invention is an adapter 500 for use with a wearable accessory item 100 to convert a conventional accessory item 100 to a wearable accessory item as described above. As shown in the examples in FIGS. 8-12, adapter 500 comprises a mounting plate 520, pry plate 530, and pry bar 540, as described above. Mounting plate 520 is configured to integrate with the accessory item to secure the adapter 500 thereto. In an example, mounting plate 520 slides or snaps onto conventional accessory item. In an example shown in FIG. 12, mounting plate 520 has feet 525a, b that snap through strap 510 of conventional accessory item. In another example, strap 510 of conventional accessory item is woven through bars 525a, b on mounting plate 520, as shown in FIG. 11A In the example shown in FIG. 8, adapter 500 is positioned over a conventional buckle.

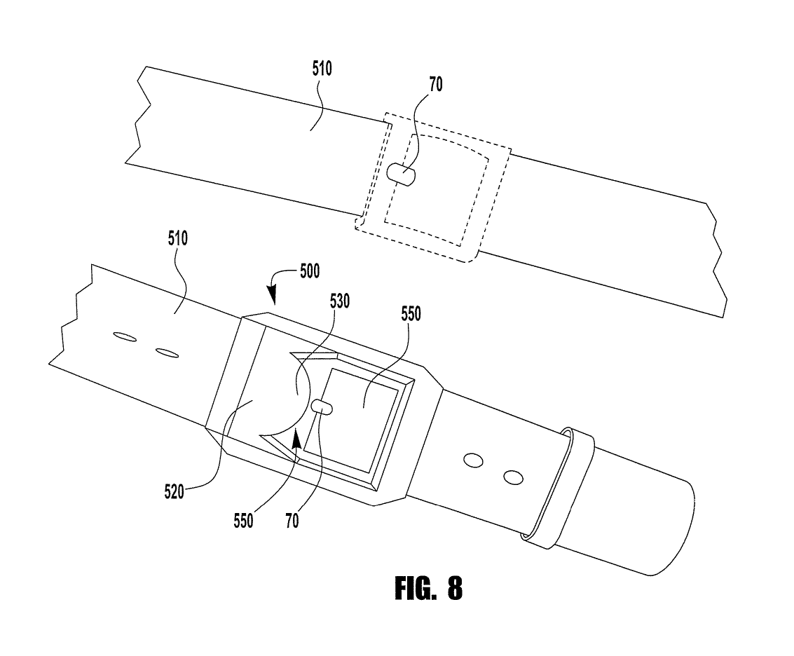

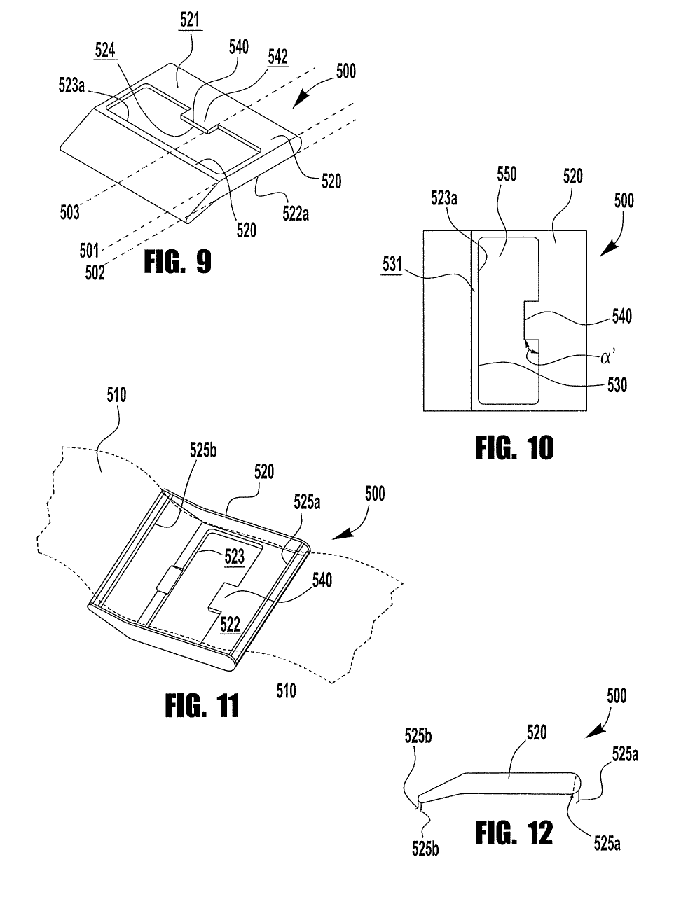

Adapter 500 further comprises a mounting plate 520 that has first 521 and second surfaces 522 and a third surface 523 therebetween. See FIG. 9-12. In an example, mounting plate 520 has a fourth surface 524, as shown in FIG. 8. First and second surfaces 521, 522 each have an edge 521a, 522a that defines first and second planes 501, 502, respectively. In an example, first and second planes 501, 502 are substantially parallel. Edges 521a, 522a are either curved (not shown), flat (FIGS. 8-12), or a combination thereof (not shown). In examples, mounting plate 520 has lengths and widths ranging from about 33 to about 52 mm. Mounting plate 520 has at least one attachment means 525 for attachment to the strap. Attachment means 525 may be at least one bar 525a, 525b on mounting plate 520 through which strap 510 of conventional accessory item is woven (FIG. 11), a snap that snaps to conventional accessory item, such as over buckle as shown in FIG. 8, at least one groove that slides over conventional accessory item (not shown), or feet that can be inserted into strap. Mounting plate 520 may be any size, shape, or material that does not interfere with the functionality of the adapter piece or the conventional accessory item such that mounting plate 520 is able to stabilize the bottle cap 210 and avoid breakage and/or injury during use. In examples, mounting plate 520 is made from stainless steel, nickel-plated steel, pure or recycled metals, or titanium. In examples, mounting plate 520 is a solid piece of material (not shown). In other examples, mounting plate 520 has at least one hole 527 extending therethrough (see FIGS. 8-12).

The adapter 500 further comprises a pry plate 530 and a pry bar 540. Pry plate 530 projects from the third surface 523 of the mounting plate 520. Pry plate 530 may be of any shape that does not interfere with the purpose of the claimed invention, including semi-circular (FIG. 8) or straight (FIGS. 9-12). Pry plate 530 must be of sufficient thickness that it is able to remove bottle cap 210 from bottle 200 without damage to adapter 500, bottle 200, and/or injury to the user. Pry plate 530 has a first engaging surface 531 that engages a surface 211 of the bottle cap 210 when bottle cap 210 is positioned in opening 550, as described above. In examples, pry plate 530 has a thickness of about 1-3 mm and a length and width of about 0.6 to about 1.2 cm.

As shown generally in FIGS. 8-12, pry bar 540 has a second engaging surface 542 that is opposed to first engaging surface 531 and that engages a lip 212 of bottle cap 210 when bottle cap 210 is positioned in opening 550, as described below. Pry bar 540 may be of any shape or size that does not interfere with the purpose of the claimed invention, including square, rectangular, and may optionally include a lip (not shown) that engages lip 212 of bottle cap 210. In examples, pry bar 540 has a thickness of about 1-3 mm and a length and width of 0.2 to about 1.2 cm.

In an example, pry plate 530 and/or pry bar 540 are unitary with mounting plate 520. In other examples, pry plate 530 and pry bar 540 are not unitary with mounting plate 520 and are optionally made from a different material than mounting plate 520. Dimensions of pry plate 530 and pry bar 540 of adapter 500 are substantially as described above.

In examples, pry plate 530 is positioned in first plane 501 and pry bar 540 is positioned in a third plane 503 that is oriented relative to first plane 501 at angle α′ ranging from about 30° to about 90°. (See FIG. 8). In another example, pry plate 530 is positioned in second plane 502 and pry bar 540 is positioned in a third plane 503 that is oriented relative to second plane 502 at angle β ranging from about 30° to about 90°, such as is shown in FIG. 3. In other examples, third plane 503 in which pry bar is positioned is substantially parallel to first and/or second planes 501, 502 (FIGS. 9-12). Pry plate 530 and pry bar 540 may be substantially aligned or pry bar 540 may sit below pry plate 530 such that first and second engaging surfaces 531, 542 are substantially opposed. In examples where pry plate 530 projects from third surface 523 and pry bar 540 projects from fourth surface 524, pry bar 540 may have an angular projection towards first engaging surface 531 of pry plate 530.

There is an opening 550 between pry plate 530 and pry bar 540. Opening 550 may be any configuration including for example a space (FIG. 8) or a hole (FIGS. 9-12). Preferably and as described above, opening 550 has a size and shape that is generally complementary to the size and shape of at least a portion of the bottle cap 210.

The claimed invention is also a method of using the wearable accessory item 100 to remove a bottle cap 210 from a bottle 200. In an optional first step, securing means 15 is secured to secure the wearable accessory item 100 to a wearer's body. In a next step, the bottle cap 210 is positioned so that surface 211 of bottle cap 210 is in contact with first engaging surface 31 of pry plate 30 and lip 212 of bottle cap 210 is in contact with second engaging surface 42 of pry bar 40. In a next step, bottle 200 is tilted so that the surface 211 of the bottle cap 210 is pressed or forced against first engaging surface 31 of the pry plate 30 such that first engaging surface 31 engages a surface 211 of the bottle cap 210. Second engaging surface 42 of the pry bar 40 engages a lip 212 of the bottle cap 210. In optional steps, the wearable accessory item 100 is removed from the wearer's body and/or the strap 10 are detached. In a further optional step, the accessory item 100 is inverted prior to first and second engaging surfaces 31, 42 engaging the surface 211 and lip 212 of the bottle cap 210, respectively.

### SPECIFIC EXAMPLES

### Example 1

FIGS. 1A and 1C show an isometric views of an example in which the wearable accessory item is a wrist watch that comprises a band that wraps around a wearer's wrist, a mounting plate 20 attached thereto, a pry plate 30, a pry bar 40, and a decorative piece 60 that is a watch face. Mounting plate 20 is attached to strap 10 by attachment means (not shown in FIG. 1A, 1C). Mounting plate 20 is solid and has first 21, second 22, and third 23 surfaces. Edges 21a, 22a of first and second surfaces 21, 22 are slightly curved. Pry plate 30 is substantially semi-circular in shape and pry bar 40 is substantially square in shape. Pry plate 30 and pry bar 40 are unitary with mounting plate 20. Pry plate 30 and pry bar 40 project from third surface 23 of mounting plate 20 with first 31 and second 42 engaging surfaces, respectively, being substantially opposed. Pry plate 30 is positioned in first plane 1 and pry bar 40 is positioned in third plane 3. As shown, pry bar 40 has a lip 44. The outermost edge of the engaging surface 31 of pry plate 30 projects farther from third surface 23 of the mounting plate 20 than does the outermost edge of the engaging surface 42 of pry bar 40. There is an opening or space 50 between pry plate 30 and pry bar 40 into which at least a portion of a bottle cap 210 is able to fit during use.

### Example 2

FIG. 1B shows an isometric view of an example in which the wearable accessory item 100 is a wrist watch that comprises a band 10 that extends around a wearer's wrist, a mounting plate 20 attached thereto, a pry plate 30, a pry bar 40, and a decorative piece 60 that is a watch face. Mounting plate 20 has first 21, second 22, third 23, and fourth 24 surfaces. Third and fourth surfaces 23, 24 are substantially opposed and define opening 50 into which bottle cap 210 fits during use. Edges 21a, 22a of first and second surfaces 21, 22 are slightly curved. Pry plate 30 is substantially semicircular in shape and pry bar 40 is substantially square in shape. Pry plate 30 and pry bar 40 are unitary with mounting plate 20. Pry plate 30 and pry bar 40 project from third and fourth surfaces 23, 24 of mounting plate 20, respectively. Pry plate 30 is positioned in first plane 1 and pry bar 40 is positioned in third plane 3. Third plane 3 is oriented to first plane 1 at an angle of about 45°. In this example, hole 27 in mounting plate is the opening 50 into which a portion of bottle cap 210 is able to fit during use.

### Example 3

FIG. 2 shows isometric views of another example of the wearable accessory item 100. Accessory item 100 comprises a strap 10, a mounting plate 20 having first, second, and third surfaces 21, 22, 23, and a pry plate 30 and pry bar 40 unitarily formed with mounting plate 20. Second surface 22 of mounting plate 20 substantially contacts a surface 13 of strap 10. Strap 10 is a single piece to which mounting plate 20 is attached. Edges 21a, 22a of first and second surfaces 21, 22 is substantially flat. Pry plate 30 and pry bar 40 each extend substantially the length of third surface 23 of mounting plate 20 and project from third surface 23 with first and second engaging surfaces 31, 42 being substantially opposed. Pry plate 30 is positioned in first plane 1 and pry bar 40 is positioned in third plane 3, third plane 3 being oriented relative to first plane 1 at an angle α of about 45°. The outermost edge of the engaging surface 42 of pry bar 40 projects further from third surface 23 of mounting plate 20 than does outermost edge of the engaging surface 32 of pry plate 30. Opening 50 is a channel that is defined by pry plate 30 and pry bar 40 and that extends substantially the length of the edge 23a of third surface 23 of mounting plate 20. In use, at least a portion of bottle cap 210 fits within channel 50. The wearable accessory item 100 can be used when secured to a wearer's body or to another item.

### Example 4

FIGS. 3 and 4 show isometric and side views, respectively, of another example of the wearable accessory item 100. Accessory item comprises a strap 10, a mounting plate having first, second, and third surfaces 21, 22, 23, and a pry plate 30 and pry bar 40 unitarily formed with mounting plate 20. Strap 10 comprises two pieces, each piece having first and second ends 10a, 10b. First ends 10a are coinectable to secure the wearable accessory item 100 to a wearer's body or to another wearable item. Second end 10b of each piece has a shape and size that is generally complementary to that of the corresponding channel 50 and is removably inserted into the channel 50. At least one piece of strap is removed from channel 50 prior to using the accessory item 100 to remove bottle cap 210 from bottle 200.

Mounting plate 20 has first, second, and third surfaces 21, 22, 23. Edges 21a, 22a of first and second surfaces 21, 22, respectively, is substantially flat. Pry plate 30 and pry bar 40 are unitarily formed with mounting plate 20 and project from third surface 23. Pry plate 30 is positioned in second plane 2 and pry bar 40 is positioned in third plane 3, third plane 3 being oriented relative to second plane 2 at an angle α of about 45°. Pry plate 30 and pry bar 40 each extend substantially the length of edge 23a third surface 23 of mounting plate 20 and project from third surface 23 with first and second engaging surfaces 31, 42, respectively, being substantially opposed. The outermost edge of the engaging surface 42 of pry bar 40 projects further from third surface 23 of mounting plate 20 than does outermost edge of the engaging surface 31 of pry plate B30. Opening 50 is a channel that is defined by pry plate 30 and pry bar 40 and that extends substantially the length of the edge 23a of third surface 23 of mounting plate 20. At least a portion of bottle cap 210 fits within channel 50. Prior to use, at least one piece of strap is removed from channel and wearable accessory item 100 is inverted.

### Example 5

FIG. 5 shows an isometric view of an example in which the wearable accessory item 100 is a belt that comprises a strap 10 that wraps around a wearer's waist, a mounting plate 20 attached thereto, a pry plate 30, and a pry bar 40.

In the example shown in FIG. 5C, strap 10 is one piece and is secured around wearer's body by prong 70. Mounting plate 20 has a hole 27 extending therethrough and first, second, third, and fourth surfaces 21, 22, 23, 24. Edges 21a, 22a of first and second surfaces 21, 22 are slightly curved. Pry bar 30 is substantially semicircular in shape and pry bar is substantially square. Pry bar 40 has a lip 44. Pry plate 30 and pry bar 40 are unitary with mounting plate 20 and project from third and fourth surfaces 23, 24, respectively. Pry plate 30 is positioned in first plane 1 and pry bar 40 is positioned in third plane 3, projecting slightly upwardly towards first engaging surface 31 of pry plate 30 at an angle α of about 45°. In this example, pry plate 30 and pry bar 40 has a thickness of about 2 to 2.9 mm and mounting plate 20 has lengths and widths of about 4.8 to about 8.5 cm.

In the examples shown in FIGS. 5A, 5B, mounting plate 20 is attached to strap 10. Mounting plate 20 has a hole 27 extending therethrough and first, second, and third surfaces 21, 22, 23. Edges 21a, 22a of first and second surfaces 22, 23 are substantially flat. Pry plate 30 is substantially semicircular in shape and pry bar 40 is substantially square in shape. Pry plate 30 and pry bar 40 are unitary with mounting plate 20 and project from third surface 23 with first and second engaging surfaces 31, 42, respectively, being substantially opposed. Pry plate 30 is positioned in first plane 1 and pry bar 40 is positioned in third plane 3, projecting slightly upwardly towards first engaging surface 31 of pry plate 30 at an angle α of about 45°. The outermost edge of first engaging surface 31 projects farther from outermost edge of second engaging surface 42. See FIG. 5B.

There is an opening 50 or space between pry plate 30 and pry bar 40 into which at least a portion of a bottle cap 210 is able to fit during use. The wearable accessory item 100 shown can be used while attached to the wearer or to another item.

### Example 6

FIG. 6 shows isometric views of examples in which the wearable accessory item 100 has a buckle and comprises a strap 10, a mounting plate 20 attached thereto, a pry plate 30, and a pry bar 40. Mounting plate 20 is attached to strap 10. Mounting plate 20 has first, second, third and fourth surfaces 21, 22, 23, 24. Third and fourth surfaces 23, 24 are substantially opposed and define opening 50 into which bottle cap 210 fits during use. Edges 21a, 22a of first and second surfaces 21, 22 are flat. Third edge 23a of third surface 23 forms pry plate 30 and pry bar 40 is substantially square in shape. Pry plate 30 is positioned in first plane 1 and pry bar 40 is positioned in third plane 3, which is substantially parallel to first plane 1. Hole 27 in mounting plate 20 is the opening 50 into which a portion of bottle cap 210 is able to fit during use. In use, prong 70 is disengaged from strap 10 and is positioned to expose opening 50 for insertion of bottle cap 200. In the example shown, prong 70 is positioned over third surface 23 in use.

### Example 7

FIG. 7 shows isometric views of examples in which the wearable accessory item 100 is a clip-on watch attached to either a belt loop (FIG. 7A) or a backpack or bag (FIG. 7B). Wearable accessory item 100 comprises a clip 10, a mounting plate 20 attached thereto, a pry plate 30, and a pry bar 40. Mounting plate 20 has a hole 50 extending therethrough and first, second, third, and fourth surfaces 21, 22, 23, 24. Edges 21a, 22a of first and second surfaces 21, 22 are round. Pry plate 30 is substantially semicircular in shape and pry bar 40 is substantially square. Pry bar 40 has a lip 44. Pry plate 30 and pry bar 40 are unitary with mounting plate 20 and project from third and fourth surfaces 23, 24, respectively. Pry plate 30 is positioned in first plane 1 and pry bar 40 is positioned in third plane 3. First and third planes 1, 3 are substantially parallel. Pry bar 40 has a lip 44. Hole 27 in mounting plate 20 is opening 50 into which bottle cap 210 fits during use.

### Example 8

FIG. 8 shows a top view of an example of an embodiment of an adapter 500 that slides over or clips or snaps onto buckle 575. A top view of conventional accessory item 590 having buckle 575 and strap 510 is also shown. Adapter 500 comprises a mounting plate 520, a pry plate 530, and a pry bar 540. Mounting plate 520 has first 521, second 522, and third 523 surfaces. Edges 521a, 522a of first and second surfaces 521, 522 are substantially flat or straight. Pry plate 530 is substantially semicircular in shape. Pry plate 530 and pry bar 540 project from third surface 523 of mounting plate 520 with first 531 and second 542 engaging surfaces, respectively, being substantially opposed. Pry plate 530 is positioned in first plane 501 and pry bar 540 is positioned in third plane 503. There is an opening 550 between pry plate 530 and pry bar 540 into which at least a portion of a bottle cap 210 is able to fit during use.

### Example 9

FIGS. 9-12 show views of an example of an embodiment of adapter 500. Adapter 500 comprises a mounting plate 520, a pry plate 530, and a pry bar 540. As shown in FIG. 11, attachment means 525 is a pair of bars 525a, 525b through which strap 510 is woven or threaded. As shown in FIG. 12, attachment means 525 is at least one pair of feet 525c, 525d that protrude through strap 510. Mounting plate 520 has first 521, second 522, third 523 and fourth 524 surfaces. Third and fourth surfaces 523, 524 are substantially opposed and define opening 550 into which bottle cap 210 fits during use. Edges 521a, 522a of first and second surfaces 521, 522 are flat. Third surface 523 forms pry plate 530 and pry bar 540 is substantially square in shape. Pry plate 530 is positioned in first plane 501 and pry bar 540 is positioned in third plane 503, which is substantially parallel to first plane 501. Hole 527 in mounting plate 520 is the opening 550 into which a portion of bottle cap 210 is able to fit during use.

While the foregoing has been set forth in considerable detail, it is to be understood that the drawings and detailed embodiments are presented for elucidation and not limitation. Design variations, especially in matters of shape, size and arrangements of parts may be made but are within the principles of the invention. Those skilled in the art will realize that such changes or modifications of the invention or combinations of elements, variations, equivalents or improvements therein are still within the scope of the invention as defined in the appended claims.

We claim:

1. A wearable accessory item, said item comprising:
a. a strap;
b. a mounting plate having first and second surfaces and a third surface therebetween and at least one attachment means that attaches said mounting plate to said strap;
c. a pry plate projecting from one of said surfaces of said mounting plate and having a first engaging surface that engages a surface of a bottle cap; and
d. a pry bar having a second engaging surface that engages a lip of said bottle cap,
there being an opening between said pry plate and said pry bar, said opening having a size and shape that is generally complementary to a size and shape of at least a portion of said bottle cap.

2. A wearable accessory item as in claim 1 further comprising a fourth surface.

3. A wearable accessory item as in claim 1 wherein said pry bar projects from one of said surfaces of said mounting plate.

4. A wearable accessory item as in claim 2 wherein said pry bar projects from one of said surfaces of said mounting plate.

5. A wearable accessory item as in claim 1 wherein at least one of said pry plate or said pry bar projects from said third surface of said mounting plate.

6. A wearable accessory item as in claim 1 wherein said pry plate is positioned in a plane and said pry bar is positioned in a different plane, said planes being oriented to each other at an angle.

7. A wearable accessory item as in claim 1 wherein at least one of said pry plate and said pry bar is unitary with said mounting plate.

8. A wearable accessory item as in claim 1 wherein an end of said band is removably inserted into said opening, said end being removed from said opening prior to use.

9. A wearable accessory item as in claim 1 wherein said engaging surfaces are substantially opposed.

10. A wearable accessory item as in claim 1 wherein said strap comprises at least one piece.

11. A wearable accessory item as in claim 1 further comprising at least one decorative piece.

13. A wearable accessory item, said item comprising:
a. a mounting plate having first and second surfaces and a third surface therebetween;
b. a pry plate having a first engaging surface, said pry plate projecting from said third surface of said mounting plate and being positioned in a plane;
c. a pry bar having a second engaging surface substantially opposed to said first engaging surface, said pry bar projecting from said third surface of said mounting plate and being positioned in a different plane, said planes being positioned relative to each other at an angle, said pry plate and pry bar defining a channel therebetween, said channel having a size and shape that is generally complementary to a size and shape of at least a portion of a bottle cap; and
d. a removable strap inserted into said channel, said strap being removed from said channel prior to use.

14. A wearable accessory item as in claim 13 wherein at least one of said pry plate and said pry bar is unitary with said mounting plate.

15. A wearable accessory item as in claim 13 wherein said strap comprises at least one piece.

16. A wearable accessory item as in claim 13 further comprising at least one decorative piece.

17. An adapter for use with a conventional wearable accessory item to convert said conventional item to a bottle opening device, said adapter comprising:
a. a mounting plate configured to integrate with said accessory item to secure said adapter to said wearable accessory item and having first and second surfaces, and a third surface therebetween;
b. a pry plate projecting from on of said surfaces of said mounting plate and having a first engaging surface that engages a surface of a bottle cap; and
c. a pry bar having a second engaging surface that engages a lip of said bottle cap,
there being an opening between said pry plate and said pry bar, said opening having a size and shape that is generally complementary to a size and shape of at least a portion of said bottle cap.

18. An adapter as in claim 13 wherein said pry plate is positioned in a plane and said pry bar is positioned in a different plane, said planes being oriented to each other at an angle.

19. A method of using a wearable accessory item to remove a cap from a bottle, said wearable accessory item comprising a strap, a mounting plate having first, second and third surfaces and at least one attachment means that attaches said mounting plate to said strap, a pry plate positioned in a plane and projecting from one of said surfaces, and a pry bar that is positioned in a different plane, said pry plate and said pry bar defining an opening, said method comprising the steps of:
a. securing said strap of said wearable accessory item to a user or to a wearable article;
b. positioning said cap in said opening, a surface of said cap contacting a first engaging surface of said pry plate and a lip of said cap contacting a second engaging surface of said pry bar;
c. pressing said surface of said cap against said first engaging surface such that said second engaging surface engages said lip of said bottle; and
d. removing said cap from said bottle.

20. A method of using said wearable accessory item as in claim 19, said method further comprising at least one of the following steps:
a. releasing said strap from said user or said wearable article;
b. removing said strap from said opening;
c. inverting said wearable accessory item; or
d. a combination thereof.
